(19) United States
(12) Patent Application Publication
(10) Pub. No.: US 2024/0238943 A1
(43) Pub. Date: Jul. 18, 2024

(54) Tool Head for a Hydraulic Power Tool

(71) Applicant: Milwaukee Electric Tool Corporation, Brookfield, WI (US)

(72) Inventors: Benjamin J. Tretow, Mequon, WI (US); Mathew R. Rentmeester, Wauwatosa, WI (US); Patrick Jalabert, Brookfield, WI (US); Tony Breitbach, Brookfield, WI (US); Jacob Nemec, Brookfield, WI (US)

(21) Appl. No.: 18/416,812

(22) Filed: Jan. 18, 2024

Related U.S. Application Data
(60) Provisional application No. 63/480,425, filed on Jan. 18, 2023.

(51) Int. Cl. B25B 7/12; B25B 27/10

(52) U.S. Cl. CPC B25B 7/126; B25B 27/10

(57) ABSTRACT

Embodiments of the disclosure provide a tool head for a hydraulic tool. The tool head includes a variety of lightweight, high-strength materials, such as titanium, titanium alloys, and carbon fibers. The tool head can be configured as a cutting, crimping, or pressing tool head.

### RELATED APPLICATIONS

This application claims priority under 35 U.S.C. § 119 to U.S. Provisional Patent Application No. 63/480,425 filed on Jan. 18, 2023, the entire contents of which is incorporated herein by reference.

### BACKGROUND

Crimpers and cutters often include a crimping or cutting head and certain crimping and cutting features, depending on the particular configuration of the tool. Some crimpers and cutters can be configured as a hydraulic power tool. Hydraulic power tools can generally include a piston that can exert force on a crimping, pressing, or cutting head. The piston can be used to move crimping or cutting features to perform crimp work, compression work, or cuts at a targeted location. The size of the crimping and cutting features, as well as their material composition, affect the weight and usability of the tool. In some cases, it may be useful to have a lighter weight crimper or cutter tool.

### SUMMARY

Embodiments of the disclosure can provide a tool head for a hydraulic tool. The tool head can include a variety of lightweight, high-strength materials, including titanium, titanium alloys, and carbon fibers.

Embodiments of the disclosure provide a working head for a hydraulic power tool. The working head can include a head frame, a first die holder, a second die holder, and an insert. The first die holder can be moveable along the head frame. The first die holder can be adapted to receive a first die. The second die holder can be coupled to the head frame and adapted to receive a second die. The insert can be arranged along the head frame and positioned to absorb a maximum stress during a crimping action. At least one or more of the head frame, the first die, the second die, or the insert can comprise one or more of titanium or carbon fiber.

Embodiments of the disclosure provide a tool head for a hydraulic tool, the hydraulic tool including a hydraulic ram. The tool head can include a first jaw, a first bushing, a second jaw, and a second bushing. The first jaw can include a first jaw insert and a first wear insert. The first jaw insert can be arranged to engage a work piece and the first wear insert can be arranged to engage the hydraulic ram. The first jaw can be arranged to rotate around the first bushing. The second jaw can include a second jaw insert and a second wear insert. The second jaw insert can be arranged to engage the work piece and the second wear insert can be arranged to engage the hydraulic ram. The second jaw can be arranged to rotate around the second bushing. The first jaw and the second jaw can comprise carbon fiber or a titanium alloy, and the first and second jaw inserts and the first and second jaw bushings can comprise steel.

Embodiments of the disclosure can provide a method of forming a carbon fiber jaw for a hydraulic tool. The method can include identifying a stress field in the jaw head. The stress field can include directions of force that result in stress in the jaw head when the jaw head is used in a crimping, cutting, or pressing action. The method can further include aligning fibers of carbon fiber in the direction of the stress field so that at least 75 percent of the fibers are oriented in the direction of the stress field. The method ca also include curing a composite matrix around the fibers to form the jaw head.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure:

FIG. 1 is a side view of a hydraulic crimping tool according to an embodiment of the disclosure.

FIG. 2 is an isometric view of another tool head of a hydraulic crimping tool according to an embodiment of the disclosure.

FIG. 3 is a side view of a hydraulic crimping tool according to an embodiment of the disclosure.

FIG. 4 a front view of a tool head of the hydraulic crimping tool of FIG. 3.

FIG. 5 is an isometric side view of a hydraulic crimping tool according to an embodiment of the disclosure.

FIG. 6 is a cross-sectional side view of the hydraulic crimping tool of FIG. 5.

FIG. 7 is an isometric view of a hydraulic crimping tool with a work piece at least partially inserted into a work zone of the hydraulic crimping tool according to an embodiment of the disclosure.

FIG. 8 is a side view of a hydraulic crimping tool according to an embodiment of the disclosure.

FIG. 9 is a side view of a hydraulic crimping tool according to an embodiment of the disclosure.

FIG. 10 is an exploded isometric view of the hydraulic crimping tool of FIG. 9.

FIG. 11 is an isometric view of a hydraulic crimping tool according to an embodiment of the disclosure.

FIG. 12 is an exploded isometric view of a hydraulic crimping tool according to an embodiment of the disclosure.

FIG. 13 is a side view of a hydraulic cutting tool according to an embodiment of the disclosure.

FIG. 14 is an exploded isometric view of the hydraulic cutting tool of FIG. 13.

FIG. 15 is an isomeric view of a press tool head for a hydraulic tool according to an embodiment of the disclosure.

FIG. 16 is another isometric view of the press tool head of FIG. 15.

FIG. 17 is an isometric view of a hydraulic tool including the press tool head of FIG. 15 according to an embodiment of the disclosure.

FIG. 18 is a cross-sectional isometric view of the hydraulic press tool of FIG. 17.

FIG. 19 is an isometric view of a hydraulic crimping tool according to an embodiment of the disclosure.

FIG. 20 is a side view of a hydraulic crimping tool according to an embodiment of the disclosure.

FIG. 21 is a cross-sectional side view of the hydraulic crimping tool of FIG. 20.

FIG. 22 is an isometric view of a cutting head for a hydraulic tool according to an embodiment of the disclosure.

FIG. 23 is an isometric view of a hydraulic cutting tool according to an embodiment of the disclosure.

FIG. 24 is a cross-sectional side view of the hydraulic cutting tool of FIG. 23.

FIG. 25 is an isometric view of a jaw for a cutting tool head according to an embodiment of the disclosure.

FIG. 26 is another isometric view of the jaw of FIG. 25.

FIG. 27 is an isometric view of a hydraulic cutting tool including a blade retention assembly according to an embodiment of the disclosure.

FIG. 28 is a side view of a cutting head according to an embodiment of the disclosure.

FIG. 29 is an exploded view of the cutting head of FIG. 28.

FIG. 30 is a side view of a crimping head with a ram in an extended position according to an embodiment of the disclosure.

FIG. 31 is another side view of a crimping head according to an embodiment of the disclosure.

FIG. 32 is an isometric view of a press tool head for a hydraulic tool according to an embodiment of the disclosure.

FIG. 33 is an isolated isometric view of bushings and plates for the press tool head of FIG. 32.

FIG. 34 is an isometric view of carbon fiber orientation for a jaw plate for the press tool head of FIG. 32.

### DETAILED DESCRIPTION

The following discussion is presented to enable a person skilled in the art to make and use examples of the disclosed technology. Various modifications to the illustrated examples will be readily apparent to those skilled in the art, and the generic principles herein can be applied to other examples and applications without departing from the disclosed technology. Thus, examples of the disclosed technology are not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosed technology. Skilled artisans will recognize the examples provided herein have many useful alternatives and fall within the scope of disclosed technology.

Before any examples of the disclosed technology are explained in detail, it is to be understood that the disclosed technology is not limited in its application to the details of construction and the arrangement of components set forth in the following description or illustrated in the attached drawings. The disclosed technology is capable of other examples and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” “secured,” and “coupled” and variations thereof, as used with reference to physical connections, are used broadly and encompass both direct and indirect mountings, connections, supports, and couplings. Further, unless otherwise specified or limited, “connected,” “attached,” or “coupled” are not restricted to physical or mechanical connections, attachments or couplings.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Also as used herein, unless otherwise limited or defined, “substantially all” and derivatives thereof, relative to a reference quantity, indicates a value of 93% or more of the reference quantity (e.g., 95%, 98%, 99%, etc.). Correspondingly, a first feature that extends along or exhibits a particular quality along substantially all of the length of a reference feature extends along or exhibits the particular quality along at least 93% of the length of the reference feature. Thus, for example, a trim profile that is described as geometrically similar to a ball profile over substantially all of the ball profile is geometrically similar to the ball profile over at least 93% of the length of the reference feature (e.g., is complementarily shaped so as to nest with the ball profile over at least 93% of the relevant length).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

In some implementations, devices or systems disclosed herein can be utilized, manufactured, installed, etc. using methods embodying aspects of the disclosure. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the disclosure, of the utilized features and implemented capabilities of such device or system.

As briefly described above, hydraulic crimping, cutting, or pressing tools can include a respective crimping head or cutting head. It can be generally useful to provide lightweight and durable crimping and cutting tools. In particular, it can be generally useful to provide a lightweight and durable crimping or cutting head. In this regard, examples of the present disclosure can provide crimping or cutting heads that include lightweight materials, such as one or more of carbon fiber, titanium, or titanium alloy.

Some conventional tool heads can include (e.g., be made from) steel. In some instances, conventional tool heads can be produced via one or more manufacturing processes, including machining, extruding, stamping, forging, casting, or injection molding. Conventional steel heads are often relatively dense and can add unwanted weight to a hydraulic tool. Embodiments of the present disclosure can address these and other drawbacks of conventional hydraulic tool heads.

In general, carbon fiber materials can provide relatively high stiffness, high tensile strength, high strength to weight ratio, high chemical resistance, high-temperature tolerance, and low thermal expansion, particularly in comparison to steel. Carbon fibers can include fibers that are approximately 5 to 10 micrometers in diameter and can be composed of primarily carbon atoms. Carbon fiber can be produced from carbon atoms that are bonded together in crystals that are generally aligned parallel to the fiber's long axis as the crystal alignment gives the fiber a high strength-to-volume ratio. Thousands of carbon fibers can be bundled together to form a tow, which can be used by itself or woven into another material.

In some applications, carbon fibers can be combined with other materials to form a composite. For example, carbon fibers can be incorporated into a metal matrix to form a composite or be used as a reinforcing material in a variety of polymers or ceramics. Carbotanium can include a combination of titanium and a carbon composite. In particular, carbotanium can include a beta titanium alloy that includes titanium mixed with relatively small quantities of other metals, including aluminum and vanadium, for example.

In general, titanium is a low density and high strength metal that is resistant to corrosion. In particular, titanium has the highest strength-to-density ratio of any metallic element. Titanium can be alloyed with a variety of elements, including, for example, iron, aluminum, vanadium, and molybdenum. Like carbon fiber, titanium is a high-strength material with low thermal expansion. In use, titanium can be cast, forged, machined from billet titanium, or otherwise molded to form a variety of components, including crimping, cutting, and pressing heads for hydraulic tools.

In some embodiments, cast titanium tool heads can be cast in a vacuum, followed by hot isostatic pressing, followed by a stress relieving treatment. The stress relieving treatment can include a heat treatment or a heat treatment followed by a cooling treatment. After the stress relieving treatment, the tool head can be finished via a machining process.

Embodiments of the disclosure provide tool heads and tool head inserts that can be made from non-steel, high strength-materials. Examples of materials include carbon fiber and titanium alloys, such as, for example Ti-6Al-4V, Ti-10V-2Fe-3Al, Ti-15V-4Al-3Cr-3Sn, Ti-3Al-8V-6Cr-4Zr-4Mo, Ti-5.8Al-4.0Sn-3.5Zr-0.5Mo-0.7Nb-0.35Si, Ti-6al-2.75Sn-4Zr0.4Mo-0.45Si, Ti-6Al-2Sn-4Zr-2Mo, and Ti-6Al-2Sn-4Zr-6Mo.

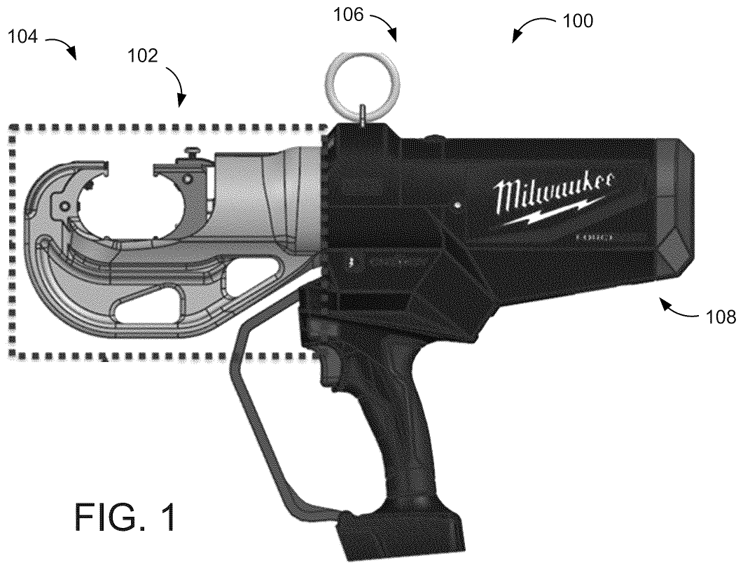

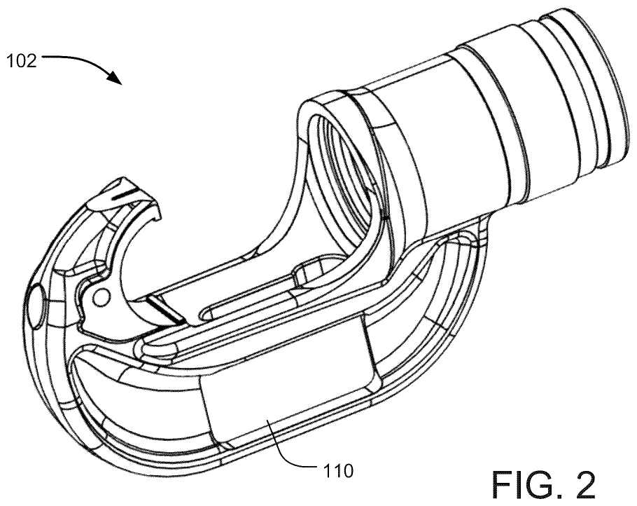

With reference to FIGS. 1 and 2, a hydraulic tool 100 according to an embodiment of the present disclosure is shown. The hydraulic tool 100 can be configured as a crimping tool. However, in other embodiments, the hydraulic tool 100 can be configured as a cutting tool having a cutting head. As shown, the hydraulic tool 100 includes a crimping head 102 at a tool working end 104 of the hydraulic tool 100. The hydraulic tool 100 can further include a main tool section 106 and a tool transmission end 108. The crimping head 102 generally defines a C-shaped body. However, in other embodiments a tool head can include other geometries, such as a U-shaped body having a latch. Still in other embodiments, a tool head can be configured as a cutting tool head.

The crimping head 102 can include a first die holder and a second die holder (e.g., a moveable die holder and a stationary die holder). In some embodiments, the moveable die holder can be coupled to or integrally formed with a ram of hydraulic tool 100. Each die holder can be configured to hold a respective die. The hydraulic tool 100 can include one or more materials, such as carbon fibers, titanium, titanium alloys, or carbotanium. For example, the tool head 102 can be made from one or more of carbon fibers, titanium, titanium alloys, or carbotanium. In some embodiments, the tool head 102 can include other metals such as steel, with a non-steel insert.

For example, the tool head 102 shown in FIG. 2 can comprise steel and include a non-steel insert 110. The insert 110 can be arranged along a frame of the tool head 102 where the tool head 102 receives a relatively high amount of stress during a crimping action. A portion of the frame of the tool head 102 can include an I-beam section (i.e., the cross-sectional profile forms an I). Thus, the insert 110 can be positioned to absorb stress (e.g., a maximum stress) during a crimping action.

The insert 110 can be made of one or more materials, such as carbon fibers, titanium, titanium alloys, or carbotanium that can be included in the C-shaped body of the crimping head 102. The non-steel insert 110 can be press fit, welded, or otherwise secured to the tool head 102. In the illustrated embodiment, the insert 110 can be arranged at a location along the tool head 102 that experiences maximum stress during a crimping operation. Furthermore, the materials of the head (e.g., the non-steel insert 110) can advantageously reduce the weight of the hydraulic tool 100 while providing sufficient strength to perform a crimp on a work piece.

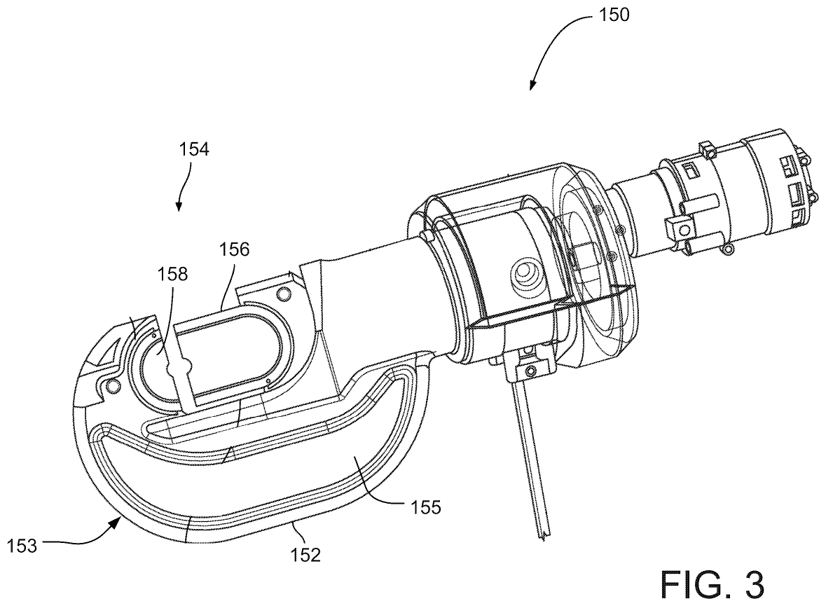

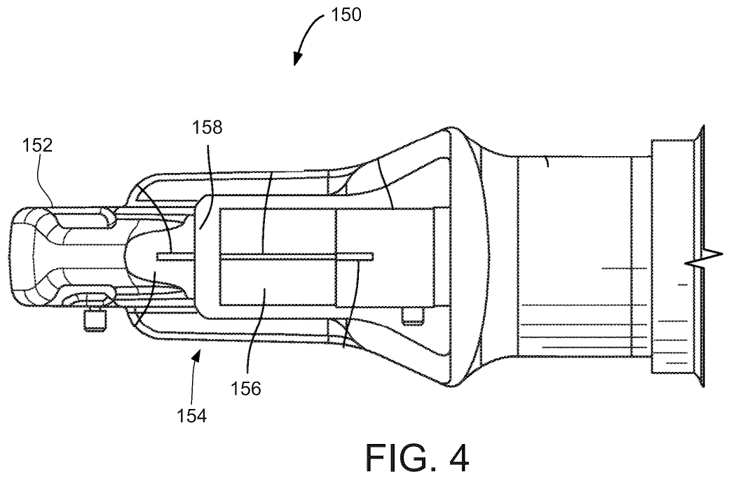

FIGS. 3 and 4 illustrate another example of a hydraulic tool 150. In the illustrated example, the hydraulic tool 150 is configured as a crimping tool. More specifically, the hydraulic tool 150 can be configured as a battery operated hydraulic crimping tool. In other embodiments, features of the present disclosure could be used in other types of hydraulic tools or pneumatic tools, or more generally, tools having a movable ram. The tool 150 generally includes a main tool section, a tool working end, and a tool transmission end.

The main tool section can include a cylinder, a ram assembly, a bladder, a hydraulic pump, a hydraulic fluid passage circuit, and a user activated release lever. The hydraulic fluid passage circuit can include a plurality of fluid passages that provide fluid communication between a fluid reservoir or bladder which provides fluid communication to and from the tool working end by way of the ram assembly. The ram assembly can include a moveable ram assembly. The ram assembly can be configured to move forward or towards a tool head 152 in order to commence a crimp of a crimping target, such as an electrical connector. The ram assembly can also be adapted to move backward, or retract away from the tool head 152.

The hydraulic tool 150 can further include a tool transmission end. The tool transmission end of the hydraulic tool 150 can include an electric motor configured to drive the hydraulic pump via a gear reducer. While the hydraulic tool 150 may comprise a battery operated hydraulic tool, in other embodiments, the main tool section could be adapted to be connected to a remote hydraulic fluid supply by hydraulic hoses.

The tool head 152 of the hydraulic tool 150 can be configured as a working head. The tool head 152 can include a C-shaped portion 153 with a recessed neck plate 155 and a die set 154. In one example, the die set 154 can include a moveable crimp die 156 and a stationary crimp die 158. The moveable crimp die 156 and the stationary crimp die 158 can include different geometrical shapes from one another. In general, the die set 154 can reduce an amount of ram assembly travel that is required per crimp. Relatedly, the die set 154 can reduce cycle time of the hydraulic tool 150, since a ram assembly, and therefore the moveable crimp die 156, can be driven a shorter distance in order to achieve a desired crimp.

In some examples, the tool head 152 of the hydraulic tool 150 can be configured as a cutting head having a cutting die set. In this regard, a stationary cutting die and a moveable cutting die can be used to cut (or otherwise slice or score) a work piece. In some embodiments, the stationary cutting die and the moveable cutting die can define different geometrical shapes, similar to the die set 154.

With continued reference to FIGS. 3 and 4, the tool head 152 can include one or more alignment features. In general, alignment features may be used to enhance an ability of a user of the hydraulic tool 150 to achieve a desired crimp or desired cut at a specific crimp target location. In this illustrated arrangement, an alignment feature can be provided along a first end face of the moveable die head. As just one example, the alignment feature may be configured as a straight, continuous line of constant width. However, other alternative alignment features may also be used, such as dashed lines, dashes, or non-uniform lines, for example.

The hydraulic tool 150 can include one or more of carbon fibers, titanium, titanium alloys, or carbotanium. For example, one or more of the tool head 152 or the die set 154 can be made from carbon fibers, titanium, titanium alloys, or carbotanium. In some embodiments, such as shown in FIG. 3, the C-shaped portion 153 of the tool head 152 can be made from carbon fibers, titanium, titanium alloys, or carbotanium. Alternatively, in some embodiments, the recessed neck plate can comprise carbon fiber or a titanium alloy while the remainder of the tool head 152 comprises steel. The materials can advantageously reduce the weight of the hydraulic tool 150 while providing sufficient strength to perform a crimp on a work piece. For example, the tool head 152 can be configured to provide an output force of approximately 12 tons (e.g., approximately 11,000 kg).

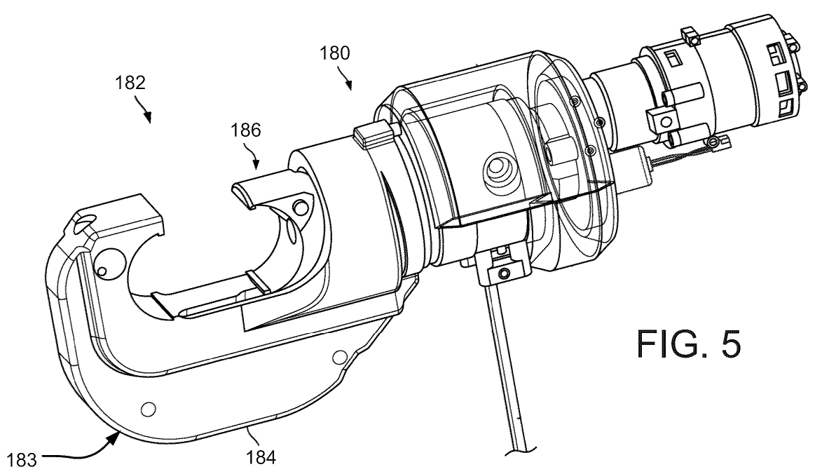

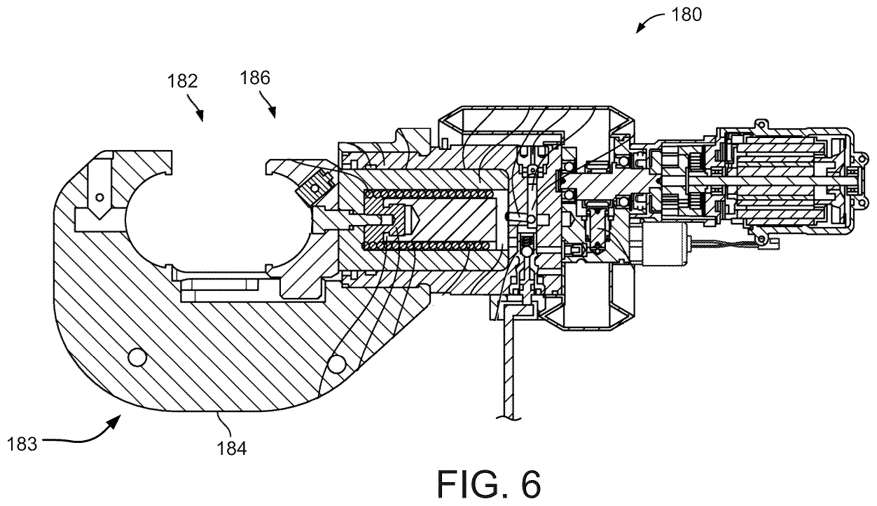

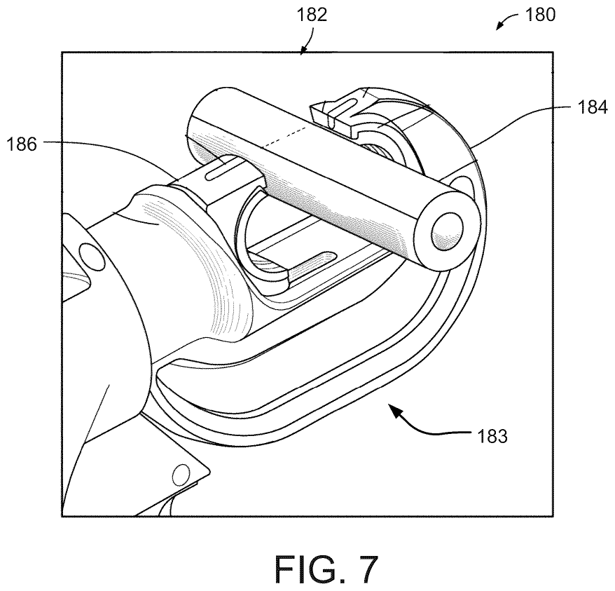

FIGS. 5-7 illustrate another example of a hydraulic tool 180. In the illustrated example, the hydraulic tool 180 is configured as a crimping tool. Similar to the hydraulic tool described above, the hydraulic tool 180 can include a main tool section, a tool working end, and a tool transmission end. At the tool working end, the hydraulic tool 180 can include a tool head 182 configured as a crimper head. The crimper head 182 can include a frame 184. A die head 186 can be axially moveable within a work zone defined by the frame 184. In the illustrated embodiment, crimper head 182 is configured as a C-style head that includes a C-shaped portion 183, however, other head geometries are possible.

The hydraulic tool 180 can include one or more of carbon fibers, titanium, titanium alloys, or carbotanium. For example, one or more of the C-shaped portion 183 of the tool head 182, the tool head 182, or the die head 186 can be made from carbon fibers, titanium, titanium alloys, or carbotanium. The materials can advantageously reduce the weight of the hydraulic tool 180 while providing sufficient strength to perform a crimp on a work piece.

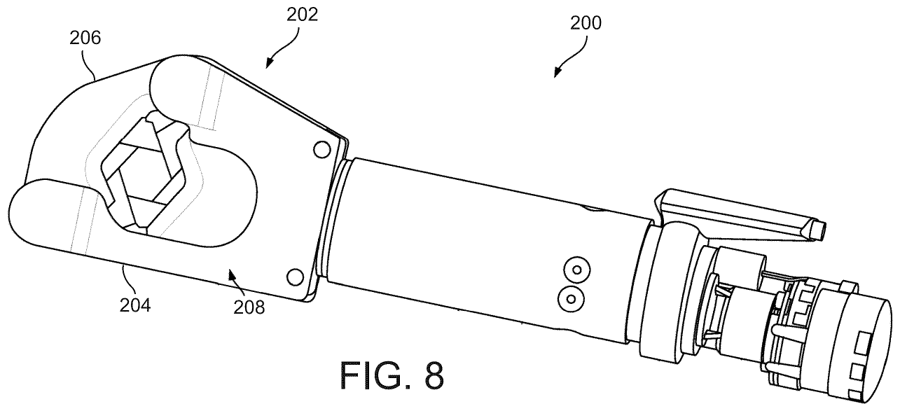

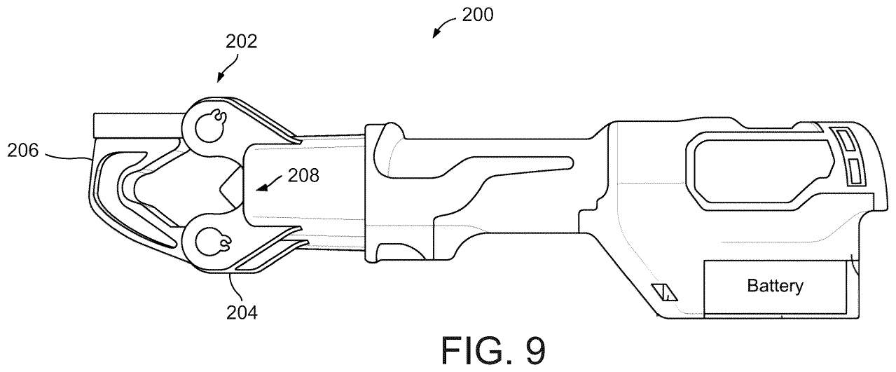

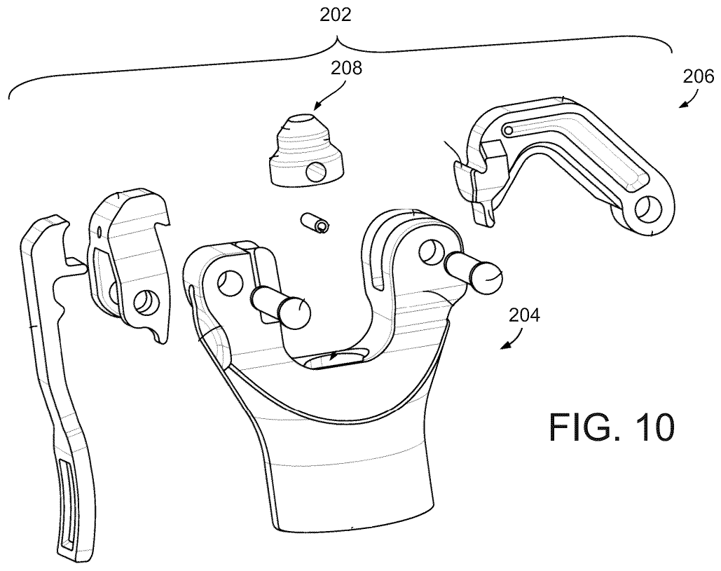

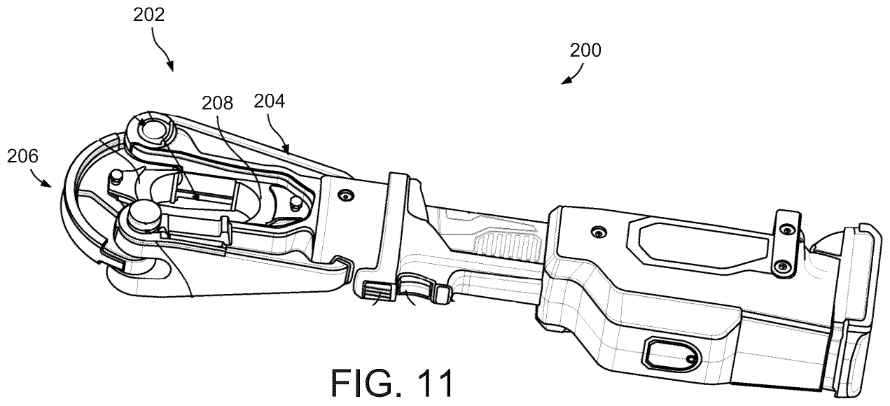

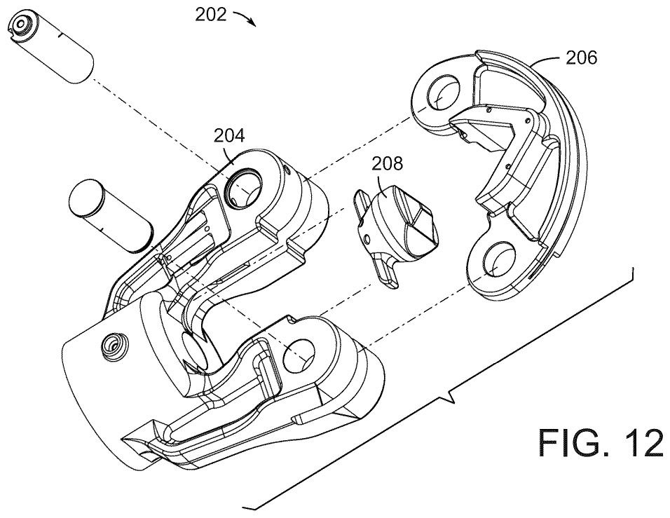

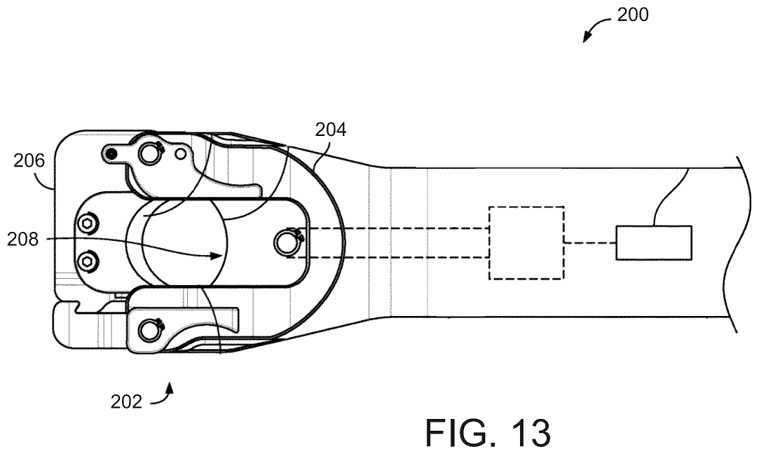

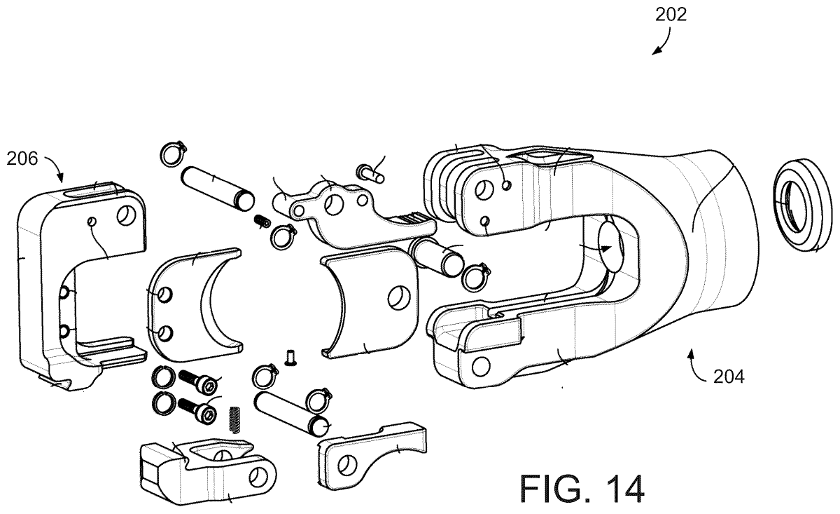

FIGS. 8-14 illustrate other examples of a hydraulic tool 200. In the illustrated examples, the hydraulic tool 200 is configured as a crimping tool or cutting tool. Similar to the hydraulic tools described above, the hydraulic tool 200 can include a main tool section, a tool working end, and a tool transmission end. At the tool working end, the hydraulic tool 200 can include a tool head 202 configured as a crimper head. The crimper head 202 can include a U-shaped body 204 and a latch assembly 206. In some embodiments, the hydraulic tool 200 can further include a crimping die 208.

The hydraulic tool 200 can include one or more of carbon fibers, titanium, titanium alloys, or carbotanium. For example, one or more of the tool head U-shaped body 204, the latch 206, or the crimping die 208 of the crimper head 202 can be made from carbon fibers, titanium, titanium alloys, or carbotanium. The materials can advantageously reduce the weight of the hydraulic tool 200 while providing sufficient strength to perform a crimp on a work piece.

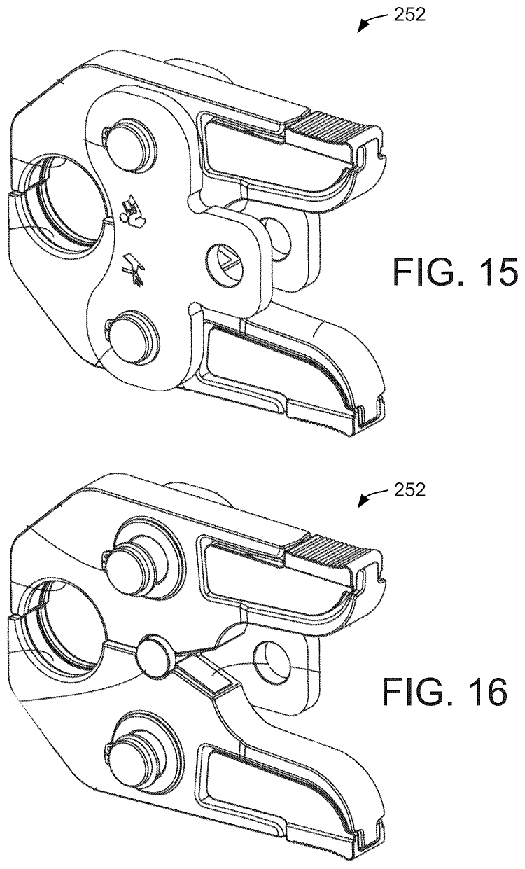

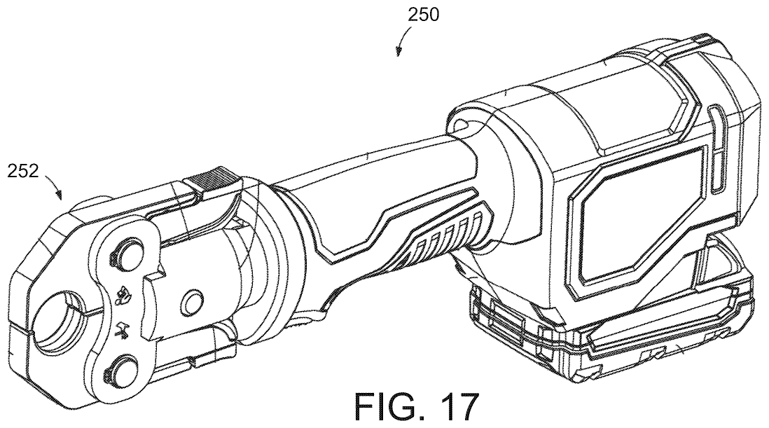

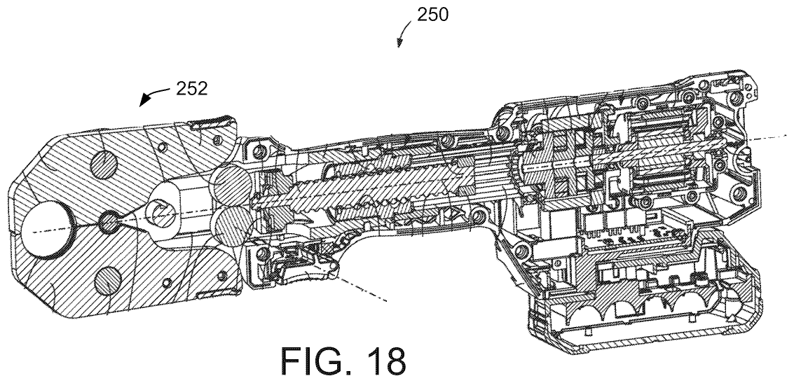

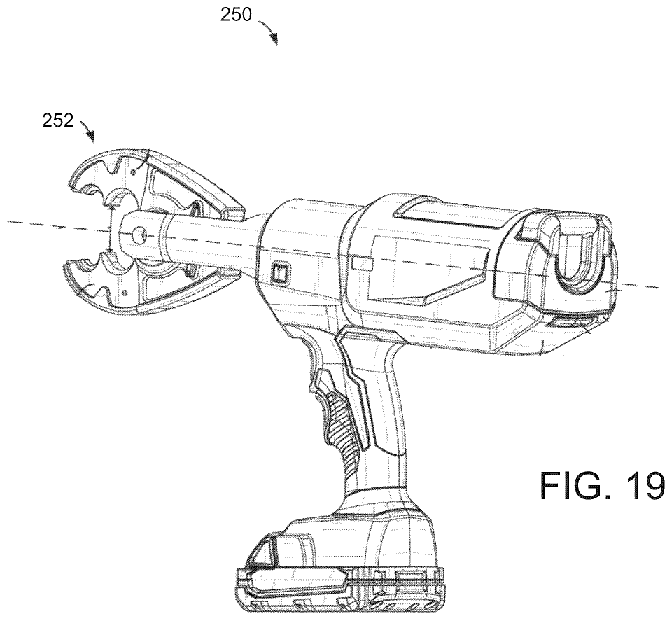

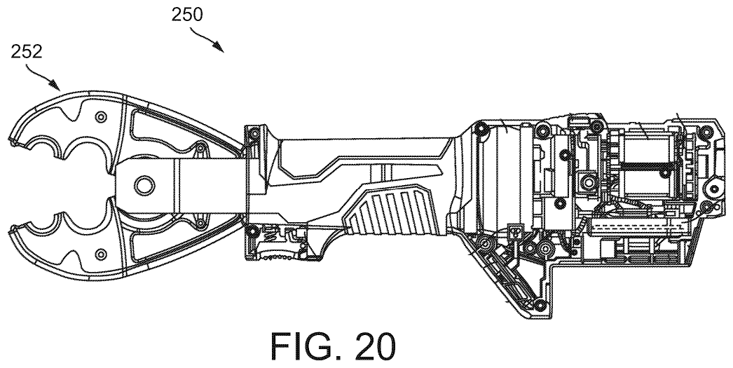

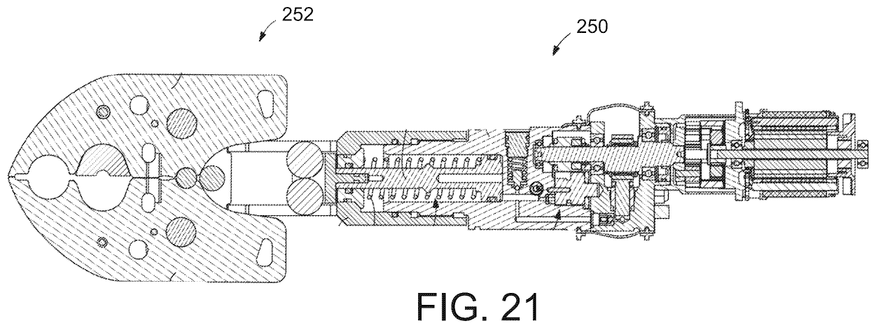

FIGS. 15-21 illustrate other examples of a hydraulic tool 250 and tool head. In the illustrated examples, the hydraulic tool 250 is configured as a crimping tool or press. Similar to the hydraulic tools described above, the hydraulic tool 250 can include a main tool section, a tool working end, and a tool transmission end. At the tool working end, the hydraulic tool 250 can include a tool head 252 configured as a crimper head. The crimper head 252 can include a pair of jaws between a work piece can be placed for a crimp.

The hydraulic tool 250 can include one or more of carbon fibers, titanium, titanium alloys, or carbotanium. For example, one or more components of the tool head 252, or the tool head 252 entirely can be made from carbon fibers, titanium, titanium alloys, or carbotanium.

The materials can advantageously reduce the weight of the hydraulic tool 250 while providing sufficient strength to perform a crimp on a work piece.

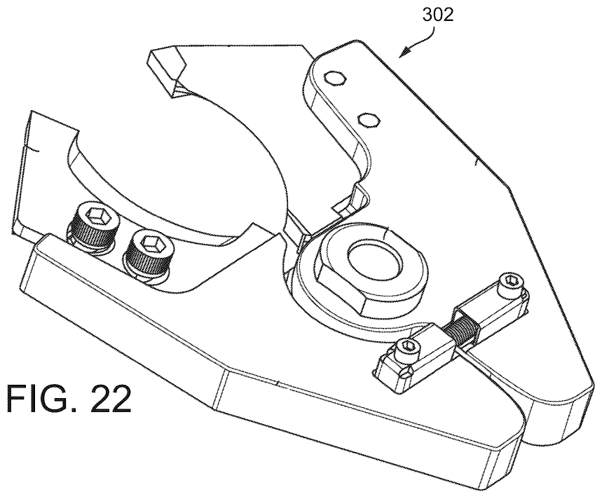

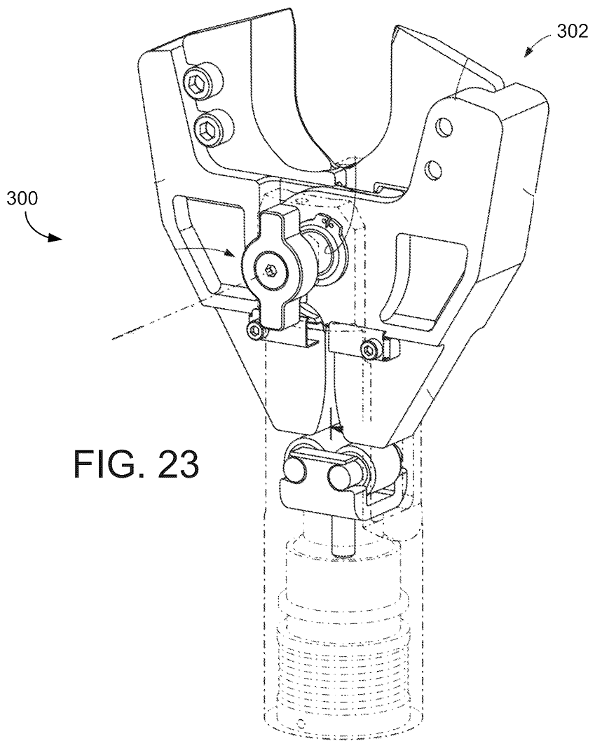

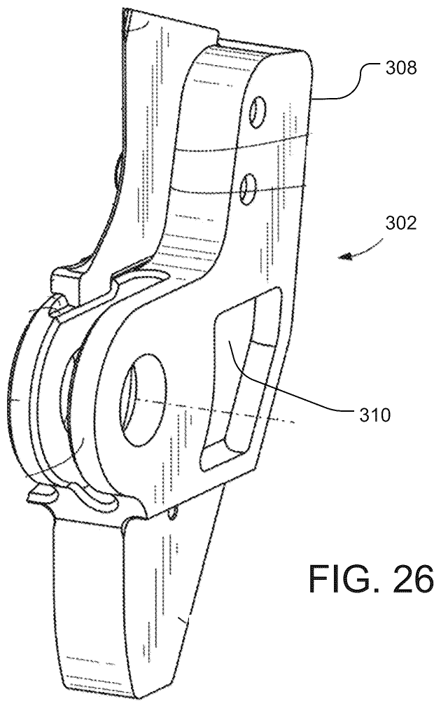

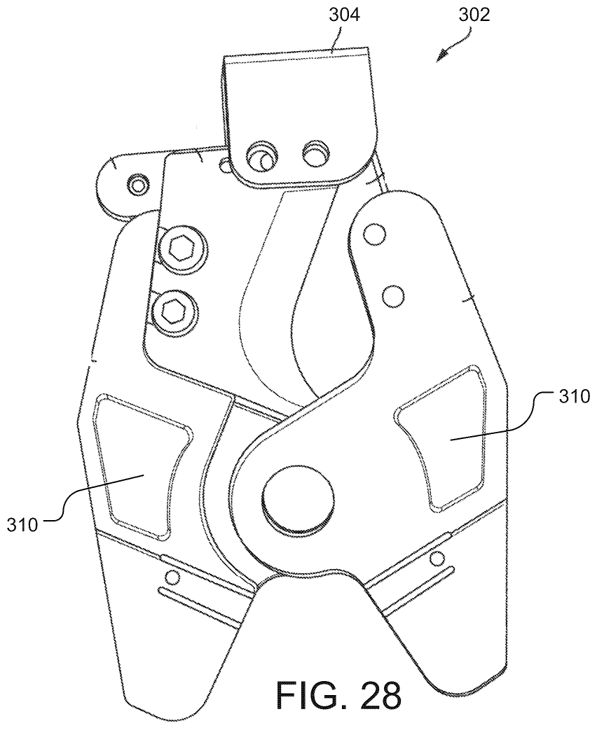

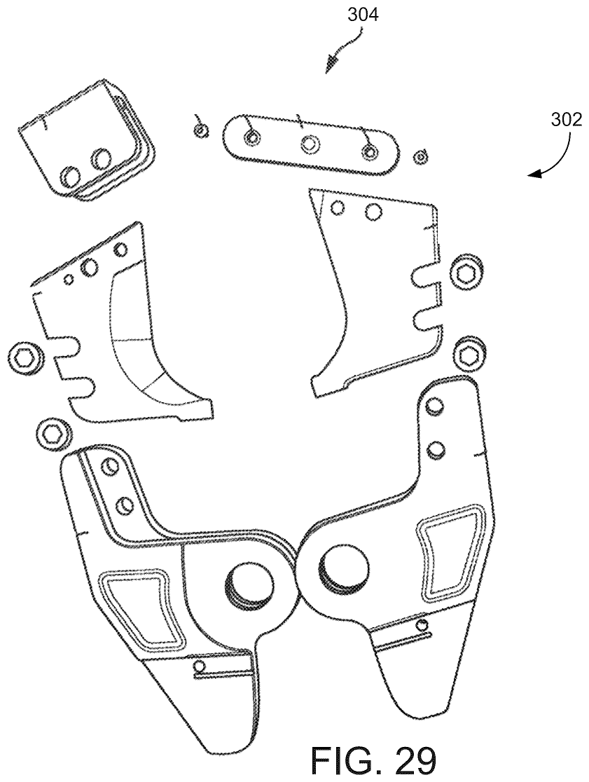

FIGS. 22-29 illustrate other examples of a hydraulic tool head 300 of a hydraulic tool. On the illustrated examples, the hydraulic tool head 300 is configured as a cutting tool. Similar to the hydraulic tools described above, the hydraulic tool can include the hydraulic tool head 300, a main tool section, a tool working end, and a tool transmission end. At the tool working end, the hydraulic tool head 300 can include a pair of jaws 302 having respective cutting blades. In some examples, the cutting blades can be integrally formed with the jaws 302, however, in other examples, the cutting blades can be coupled with the jaws 302.

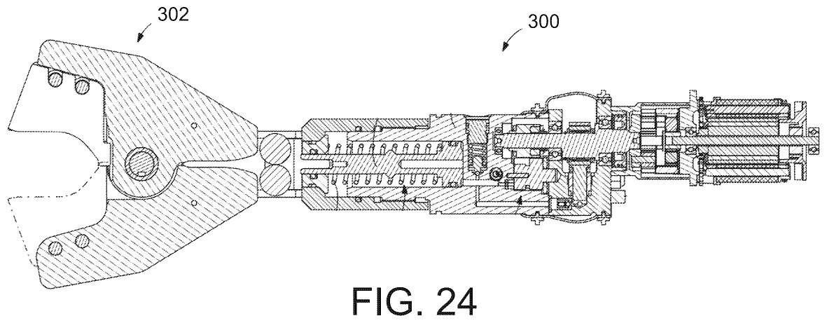

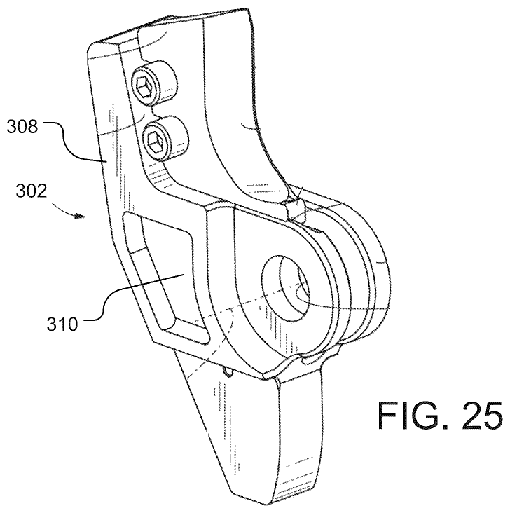

With reference to FIG. 25, the jaw 302 can include a jaw body 308 made of steel with a non-steel insert 310. The non-steel insert can include carbon fiber or titanium materials. The insert 310 can help reduce weight in the jaw 302 and provide additional strength.

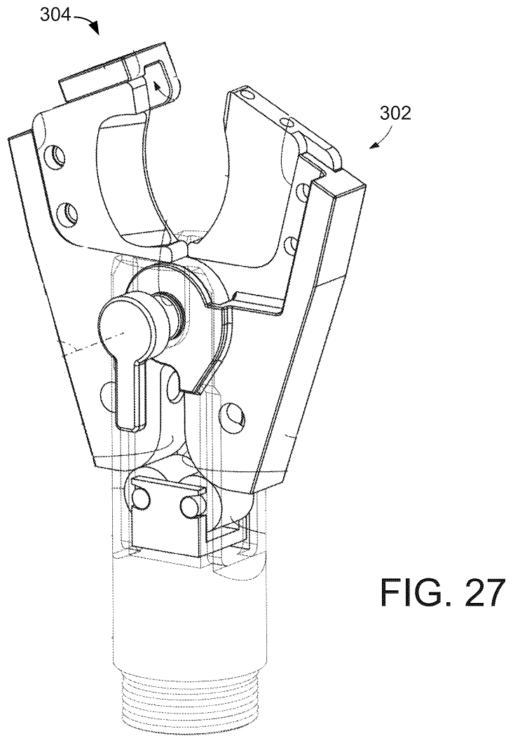

FIGS. 27-29 include examples of the hydraulic tool head 300 including a blade retention system 304. The blade retention system 304 can include a blade retainer. The blade retainer can be configured to receive one or more of a blade or flange during a cutting action to prevent the blades from shifting out of alignment during the cutting action.

The hydraulic tool head 300 can include one or more of carbon fibers, titanium, titanium alloys, or carbotanium. For example, the tool head 300, including the jaws 302 and/or the blade retention system 304, can be made from carbon fibers, titanium, titanium alloys, or carbotanium. The materials can advantageously reduce the weight of the hydraulic tool and the hydraulic tool head 300 while providing sufficient strength to perform a crimp on a work piece.

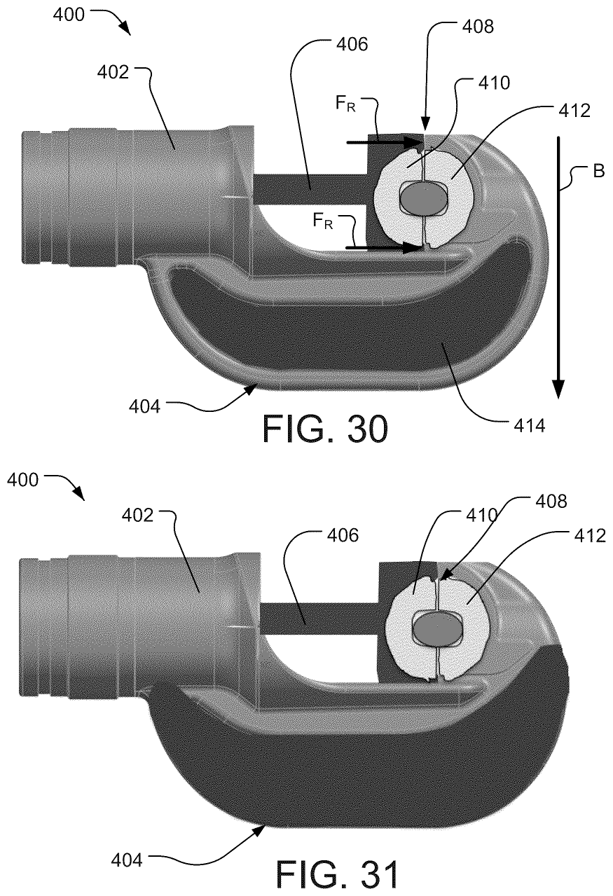

FIGS. 30 and 31 illustrate another example of a hydraulic tool 400 and tool head 402. In the illustrated examples, the hydraulic tool 400 is configured as a crimping tool. Similar to the hydraulic tool described above, the hydraulic tool 400 can include a main tool section, a tool working end, and a tool transmission end. At the tool working end, the hydraulic tool 400 can include a tool head 402. The tool head 402 can include a C-shaped neck portion 404, a moveable ram 406, and a die set 408. In one example, the die set 408 can include a moveable crimp die 410 and a stationary crimp die 412. In general, the die set 408 can reduce an amount of ram assembly travel that is required per crimp. Relatedly, the die set 408 can reduce cycle time of the hydraulic tool 400, since a ram assembly, and therefore the moveable crimp die 410, can be driven a shorter distance in order to achieve a desired crimp. In the illustrated embodiment, crimper head 402 is configured as a C-style head, however, other head geometries are possible.

In the illustrated examples shown, the moveable crimp die 410 is connected to the moveable ram 406, with the moveable ram 406 being attached to the tool head 402 using internal threads configured to transmit force onto a work piece. To perform a crimping operation on the work piece, the moveable ram 406 and the moveable crimp die 410 extend to close the die set 408. When the ram 406 contacts the upper surface of the tool head 402, a loading force is exerted on the work piece and on the tool head. This force is shown by F_{R} in FIG. 30. This force can be on the order of 24,000 pounds-force. The force F_{R} creates a bending moment in the direction B, thereby forming a stress concentration at the neck 404 of the tool head 402.

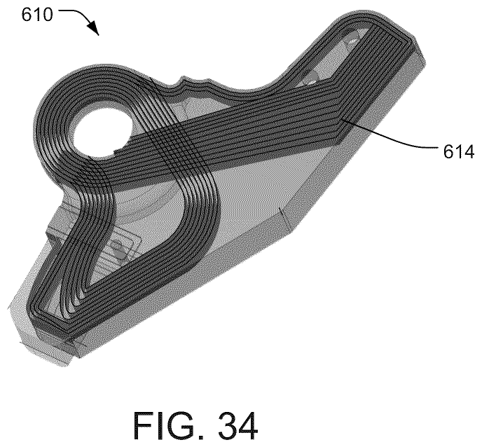

In some embodiments, the neck 404 can include an I-beam profile. The I-beam profile can include an insert 414 made of carbon fiber or a titanium alloy. This insert is shown, for example, in FIG. 30. Alternatively, in some embodiments, the neck 404 of the tool head 402 can comprise carbon fiber or a titanium alloy. Regarding the use of carbon fiber, advantages of present disclosure include the orientation of fibers of carbon fiber relative to the areas of stress concentration in the tool. That is, aligning the fibers in the direction of stress increases the strength of the tool. This will also be described in more detail with respect to FIG. 34 below. Further, in some embodiments, the ram 406 can comprise titanium to further reduce the weight of the tool.

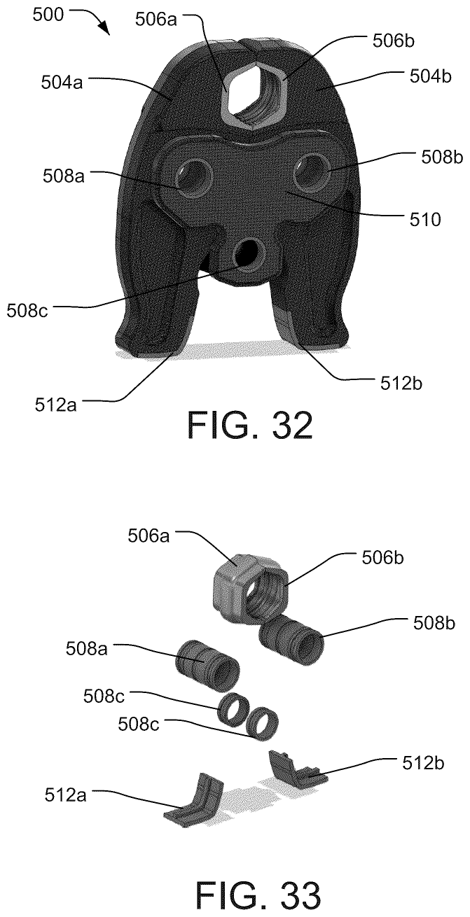

FIGS. 32 and 33 illustrate other example of a hydraulic tool head 500 and inserts according to embodiments of the present disclosure. In the illustrated example, the hydraulic tool head 500 is a press tool head. The hydraulic tool head 500 can include a pair of jaws 504a, 504b. The pair of jaws 504a, 504b can include jaw inserts 506a, 506b (e.g., crimp inserts) that steady and engage the work piece within the jaws 504a, 504b during an operation. The tool head 500 can also include cylindrical bushings 508a, 508b, 508c that secure a jaw plate 510 to and rotatably couple the jaws 504a, 504b. The jaws 504, 504b can also include a wear insert 512a, 512b that advantageously enhance the durability and lifespan of the jaws 504a, 504b by reducing friction and wear.

The bushings 508a, 508b, 508c and the inserts 506a, 506b, 512a, 512b are advantageously placed at some of the highest wear and stress points felt by the tool head 500 during the use of the tool head 500. For example, the inserts 506a, 506b bear the pressing force on a work piece, the bushings 508a, 508b, 508c bear the rotational stress as the jaws 504a, 504b are rotated, and the inserts 512a, 512b bear the force of a hydraulic ram that forces the rotation of the jaws 504a, 504b. As shown in FIG. 32, each of the inserts 512a, 512b can extend around a bottom corner of the jaws 504a, 504b. In general, the inserts 512a, 512b can be configured as wear plates that absorb wear from the hydraulic ram.

In this regard, the bushings 508a, 508b, 508c and the inserts 506a, 506b, 512a, 512bcan be made from a high-strength material, such as steel, that can withstand repeated high forces. In contrast, the body of the jaws 504a, 504b can be made of light-weight, high-strength material, such as carbon fiber or titanium alloys. These materials can advantageously reduce the weight of the hydraulic tool 500 while maintaining the strength needed to perform a press on a work piece.

Generally, a method of manufacturing titanium and titanium alloys can be performed through a metal injection molding (MIM) manufacturing process. This process can include a thermoplastic binder material, such as polyethylene, polypropylene, or polyoxymethylene. The thermoplastic binder and fine metal mixture can then be injected into molds using a conventional plastic injection molding machine, where a debinding process removes a majority of the binder material through thermal and chemical processes. The remaining binder material is then removed in a sintering process, resulting in a dense, fully metallized part. The temperature during the sintering process is below the melting point of the metal material to eliminate the binder material without liquefying the metal material. The metal may further undergo quality control checks and additional processes, such as heat treatment, machining, or surface treatments to ensure particular qualities or surface finishes. In some embodiments, for bigger components, cast molding, injection molding, investment casting, or other manufacturing processes.

In particular with titanium and titanium alloys, investment casting can be used. Investing casting includes creating and creating a mold using 3-D printing or CNC machining techniques, vacuuming the mold within a vacuum chamber, liquid casting, solidifying, and demolding the final product. The final mold product can then undergo a hot isostatic pressing process to improve the mechanical properties and eliminate defects, in particular, remove the internal porosity of the product. Stress relieving can then be performed on the final mold product to reduce the internal stresses. The final mold product is then annealed to improve ductility, machinability, and formability. Finally, the final mold product can be machined into a final component, such as a jaw, a tool head, etc.

FIG. 34 illustrates an exemplary jaw plate 610 for a hydraulic tool. The jaw plate 610 is formed out of carbon fiber 614. Though only a portion of the fibers 614 are shown in FIG. 34, it should be appreciated that the entire jaw plate 610 can comprise carbon fiber. As shown, the carbon fibers 614 are oriented primarily in a direction of a stress field that would be felt by the jaw plate 610 during a cutting action.

According to embodiments of the present disclosure, to manufacture hydraulic tool heads from carbon fiber, such as the jaw plate 610, for example, a manufacturer first identifies a stress field. The stress field includes directions of force that result in stress in the tool head when the tool head is used for a crimping, cutting, or pressing action. Once the stress field has been identified, a mold of the tool head, such as the jaw plate 610 can be formed. Carbon fibers can then be oriented along the identified stress field within the mold.

In some examples, approximately 75 percent of the carbon fibers are oriented along the direction of the stress field, however, other percentages greater than 75 percent are possible to provide a high strength tool head. Thus, as an example, FIG. 34 illustrates carbon fibers 614, such as a continuous fiber composite, positioned the direction of the stress field on the jaw plate 610 of a hydraulic tool. As shown in this embodiment, the carbon fibers 614 are aligned in different orientations along different sections of the jaw plate 610, to ensure the strongest position on different parts of the jaw plate 610. For example, when an optimal fiber orientation is achieved, a cable cutter can support a load of about 18,000 pounds of force, as compared to about 5,000 pounds of force with a poor fiber orientation.

It should be appreciated that various components of the hydraulic tools described above can be interchanged with various tool heads, tool working ends, and tool transmission ends described herein. Thus, components of the various examples described herein should not be limited to the individual examples, and various components can be incorporated into other examples and embodiments.

The previous description of the disclosed embodiments is provided to enable any person skilled in the art to make or use the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

1. A working head for a hydraulic power tool, the working head comprising:
a head frame;
a first die holder moveable along the head frame, the first die holder adapted to receive a first die;
a second die holder coupled to the head frame, the second die holder adapted to receive a second die; and
an insert arranged along the head frame and positioned to absorb a maximum stress during a crimping action;
at least one or more of the head frame, the first die, the second die, or the insert comprising one or more of titanium or carbon fiber.

2. The working head of claim 1, further comprising a moveable ram comprising titanium.

3. The working head of claim 2, wherein the first die holder is integrally formed with the moveable ram.

4. The working head of claim 1, wherein the head frame includes a section that forms an I-beam, the section that forms the I-beam including the insert.

5. The working head of claim 4, wherein the section that forms the I-beam at least partially comprises one or more of titanium or carbon fiber.

6. The working head of claim 1, wherein at least one or more of the head frame, the first die, the second die, or the insert comprise Ti 6-4.

7. The working head of claim 1, wherein the maximum stress at the insert is a result of an approximately 24,000 pound-force.

8. A tool head for a hydraulic tool, the hydraulic tool including a hydraulic ram, the tool head comprising:
a first jaw having a first jaw insert and a first wear insert, the first jaw insert arranged to engage a work piece and the first wear insert arranged to engage the hydraulic ram;
a first bushing around which the first jaw is rotatable;
a second jaw having a second jaw insert and a second wear insert, the second jaw insert arranged to engage the work piece and the second wear insert arranged to engage the hydraulic ram; and
a second bushing around which the second jaw is rotatable;
the first jaw and the second jaw comprising one of carbon fiber or a titanium alloy;
the first jaw insert, the second jaw insert, the first wear insert, the second wear insert, and the first bushing comprising steel.

9. The tool head of claim 8, further comprising a jaw plate having a third bushing comprising steel.

10. The tool head of claim 9, wherein the jaw plate comprises carbon fiber or a titanium alloy and is secured to the first jaw and the second jaw via the first bushing, the second bushing, and the third bushing.

11. The tool head of claim 10, wherein the jaw plate is a first jaw plate and the tool head further comprises a second jaw plate.

12. The tool head of claim 11, wherein the first jaw plate is secured to a first side of the first jaw and the second jaw and the second jaw plate is secured to a second side of the first jaw and the second jaw.

13. The tool head of claim 8, wherein the titanium alloy is Ti-6Al-4V.

14. The tool head of claim 8, wherein the first wear insert extends around a first corner of the first jaw and the second wear insert extends around a second corner of the second jaw.

15. A method of forming a carbon fiber jaw head for a hydraulic tool, the method comprising:
identifying a stress field in the jaw head, the stress field including directions of force that result in stress in the jaw head when the jaw head is used in a crimping, cutting, or pressing action;
aligning fibers of carbon fiber in the direction of the stress field so that at least percent of the fibers are oriented in the direction of the stress field; and
curing a composite matrix around the fibers to form the jaw head.
